(19) United States
(12) Patent Application Publication
(10) Pub. No.: US 2011/0027504 A1
(43) Pub. Date: Feb. 3, 2011

(54) HEAT-SENSITIVE TRANSFER IMAGE-RECEIVING SHEET

(75) Inventors: Kazuaki OGUMA, Minami-ashigara-shi (JP); Masaaki MIKI, Ashigarakami-gun (JP); Junichiro HOSOKAWA, Minami-ashigara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 12/847,536

(22) Filed: Jul. 30, 2010

(30) Foreign Application Priority Data
Jul. 31, 2009 (JP) 2009-179276

(51) Int. Cl. B41M 5/52

(52) U.S. Cl. 428/32.39

(57) ABSTRACT

A heat-sensitive transfer image-receiving sheet, having on a support: at least one heat insulation layer; and at least one receptor layer containing a latex polymer and polyether-modified silicone in this order, in which at least one layer provided on the side of the support having the receptor layer contains at least one fluorine-containing compound represented by formula (H):

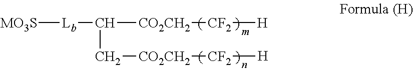

wherein m and n each independently represents an integer of 2 to 8; M represents a cation; and L_{b} represents a single bond or a substituted or unsubstituted alkylene group.

### FIELD OF THE INVENTION

The present invention relates to a heat-sensitive transfer image-receiving sheet used in a dye diffusion transfer recording.

### BACKGROUND OF THE INVENTION

In a dye diffusion transfer recording system, a heat-sensitive transfer sheet (hereinafter simply also referred to as an ink sheet) containing a colorant (hereinafter also referred to as a dye) is superposed on a heat-sensitive transfer image-receiving sheet (hereinafter simply also referred to as an image-receiving sheet), and then the heat-sensitive transfer sheet is heated by a thermal head whose exothermic action is controlled by electric signals, in order to transfer the dyes contained in the heat-sensitive transfer sheet to the image-receiving sheet, thereby recording an image information. Three colors: cyan, magenta, and yellow, or four colors which consist of the three colors and black are used for recording a color image by overlapping one color to other, thereby enabling transferring and recording a color image having continuous gradation for color densities.

In recent years, as a result of the popularization of dye diffusion transfer recording-type systems and speeding up of printing, those systems have been installed out of doors such as in amusement parks and tourist attractions, so that they have been used for an immediate printing purpose.

JP-A-2007-237617 (“JP-A” means unexamined published Japanese patent application) discloses a heat-sensitive transfer image-receiving sheet provided, on a heat insulation layer, with a receptor layer which contains a vinyl chloride-based latex and carnauba wax and utilizes an anionic fluorine-based compound.

JP-A-2006-88691 discloses a heat-sensitive transfer image-receiving sheet provided, on a heat insulation layer, with a receptor layer containing a water-dispersible polyester and a nonionic fluorine-based surfactant.

JP-A-2009-83331 discloses a heat transfer image-receiving sheet containing a polyether silicone compound in a receptor layer.

### SUMMARY OF THE INVENTION

However, a new problem occurred. That is, when images are printed out with the systems intended for the immediate printing in the outdoors as described above using these heat-sensitive transfer image-receiving sheets, unevenness of reflection gloss occurs in black and high-density image areas. Particularly when the printing environment is under high humidity conditions such as in the rain, unevenness occurs conspicuously and the image quality is impaired. Thus, it has been strongly demanded to overcome this problem.

The present resides in a heat-sensitive transfer image-receiving sheet, having on a support:

at least one heat insulation layer; and

at least one receptor layer containing a latex polymer and polyether-modified silicone in this order,

wherein at least one layer provided on the side of the support having the receptor layer contains at least one fluorine-containing compound represented by formula (H):

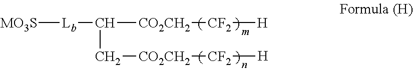

wherein m and n each independently represents an integer of 2 to 8; M represents a cation; and L_{b} represents a single bond or a substituted or unsubstituted alkylene group.

Other and further features and advantages of the invention will appear more fully from the following description.

### DETAILED DESCRIPTION OF THE INVENTION

According to the present invention, there are provided the following means:
(1) A heat-sensitive transfer image-receiving sheet, having on a support:

at least one heat insulation layer; and

at least one receptor layer containing a latex polymer and polyether-modified silicone in this order,

wherein at least one layer provided on the side of the support having the receptor layer contains at least one fluorine-containing compound represented by formula (H):

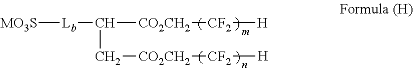

wherein m and n each independently represents an integer of 2 to 8; M represents a cation; and L_{b} represents a single bond or a substituted or unsubstituted alkylene group.
(2) The heat-sensitive transfer image-receiving sheet as described in the above item (1), wherein m and n each independently represents an integer of 2 to 6 in the fluorine-containing compound represented by the formula (H).
(3) The heat-sensitive transfer image-receiving sheet as described in the above item (2), wherein a total value of m and n is from 6 to 12 in the fluorine-containing compound represented by the formula (H).
(4) The heat-sensitive transfer image-receiving sheet as described in any one of the above items (1) to (3), wherein the latex polymer is a vinyl chloride copolymer.
(5) The heat-sensitive transfer image-receiving sheet as described in any one of the above items (1) to (4), having an intermediate layer between the heat insulation layer and the receptor layer.
(6) The heat-sensitive transfer image-receiving sheet as described in any one of the above items (1) to (5), having a subbing layer between the support and the heat insulation layer.

In the present specification, “to” denotes a range including numerical values described before and after it as a minimum value and a maximum value.

### [Heat-Sensitive Transfer Image-Receiving Sheet]

The heat-sensitive transfer image-receiving sheet of the present invention is explained in detail below.

The heat-sensitive transfer image-receiving sheet of the present invention (hereinafter also referred to as “the image-receiving sheet of the present invention”) preferably has, on or above a support, at least one heat insulation layer (heat insulating layer), and at least one receptor layer.

According to a preferred embodiment of the present invention, the heat-sensitive transfer image-receiving sheet of the present invention is provided with a subbing layer between the support and the heat insulation layer, in order to impart various functions, for example, controlling of white background, prevention of static charge, adhesiveness, cushioning properties and smoothness to the image-receiving sheet.

Furthermore, according to another preferred embodiment of the present invention, the heat-sensitive transfer image-receiving sheet of the present invention is provided with an intermediate layer between the heat insulation layer and the receptor layer, in order to impart various functions, for example, controlling of white background, prevention of static charge, adhesiveness, cushioning properties and smoothness to the image-receiving sheet.

On the side of the support opposite to the receptor layer coating side, a curl adjusting layer, a writing layer, or a static adjusting layer may be disposed.

### <Fluorine-Containing Compound>

In the present invention, the heat-sensitive transfer image-receiving sheet contains a fluorine-containing compound represented by the formula (H) on the side of the support having the receptor layer.

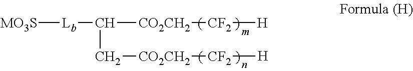

In the formula (H), m and n each independently represents an integer of 2 to 8, preferably 2 to 6, further preferably 3 to 6. The total value of m and n is preferably 6 or more to 12 or less, more preferably 6 or more to 10 or less. Among them, m and n are preferably the same, and most preferably m and n is 4.

As a cation represented by M, preferable examples thereof include metal ions (for example, lithium, sodium, and potassium ions), alkali earth metal ions (for example, barium, and calcium ions), ammonium ion or the like. Of these ions, lithium ion, sodium ion, potassium ion, and ammonium ion are more preferable, and lithium ion, sodium ion and potassium ion are particularly preferable.

L_{b} represents a single bond or an alkylene group. In a case where L_{b} represents an alkylene group, the alkylene group is preferably an alkylene group having 2 or less carbon atoms, more preferably a methylene group. It is the most preferable that L_{b} is a single bond.

It is preferable to combine the above preferable embodiments each other in the formula (H).

The specific examples of a compound represented by the formula (H) are described below. However, the compound represented by the formula (H) that can be used in the present invention is not limited thereto. In the following descriptions on the structure of the example compounds, unless particularly stated otherwise, the alkyl group and perfluoroalkyl group mean groups having a linear structure.

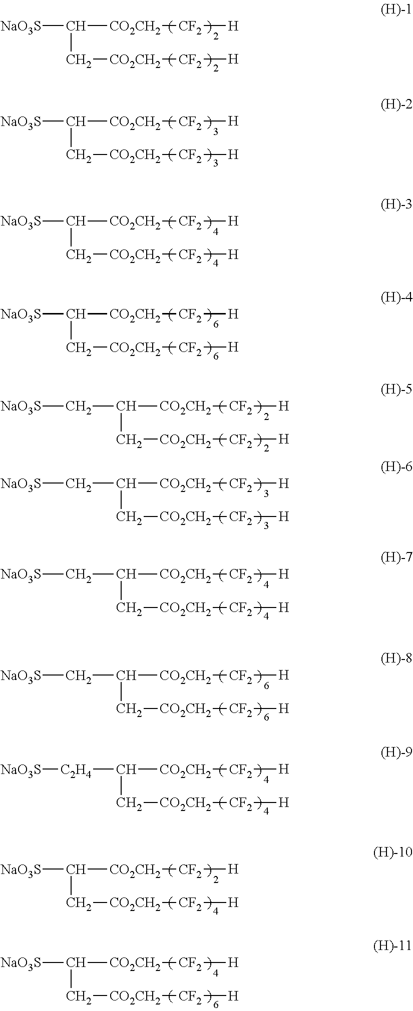

The fluorine-containing compound represented by the formula (H) not only contributes to the stabilization of surface state by imparting wettability to a coating liquid, but also has an effect of preventing gloss unevenness in high-density image areas.

The mechanism of gloss unevenness prevention is not clearly known, but it is speculated as follows. At the time of high-density printing (200 to 450° C.), the trace amount of moisture present at the surface of the heat-sensitive transfer image-receiving sheet or within a film of the heat-sensitive transfer image-receiving sheet rapidly vaporizes, and thereby a high pressure is applied locally on the surface, and the area under pressure is dented. Thus, minute surface unevenness is generated at the surface of the receptor layer. Subsequently, a heat transferable protective layer is transferred from the heat-sensitive transfer sheet to the printing area, and at this time, since a small amount of air enters into the interface between the heat transferable protective layer and the surface of the printing area, the gloss at the high density areas appears to be uneven.

Here, the action of the fluorine-containing compound is estimated and explained as follows. Since a fluorine-containing compound having —CF₂H at its terminal has weaker hydrophobicity as compared with a fluorine-containing compound having —CF₃ at its terminal, the vaporizing moisture generated at the time of high temperature printing can be rapidly diffused inside the receptor layer. Consequently, rapid pressure changes at the surface of the receptor layer at the time of printing can be prevented, and the minute surface unevenness that is causative of unevenness may not be generated.

The fluorine-containing compound represented by the formula (H) may be contained in any one layer on the side of the support provided with the receptor layer. The fluorine-containing compound is usually contained in the receptor layer, but in the case of carrying out simultaneous multi-layer coating, the effects of the present invention is exhibited even if the fluorine-containing compound is added to a layer other than the receptor layer, such as the heat insulation layer, the intermediate layer or the subbing layer. This is thought to be because the fluorine-containing compound is a relatively low molecular weight compound, and therefore the fluorine-containing compound migrates to the surface of the receptor layer during the drying step after coating.

The coating amount of the fluorine-containing compound represented by the formula (H) is preferably from 0.1 mg/m² to 100 mg/m² added, and more preferably from 1 mg/m² to 50 mg/m².

### <Receptor Layer>

The image-receiving sheet of the present invention has at least one receptor layer which contains at least a latex polymer and a polyether-modified silicone. The receptor layer plays a role of being dyed with a dye migrated from the heat-sensitive transfer sheet and maintaining a formed image.

### <Latex Polymer>

In the image-receiving sheet of the present invention, the receptor layer contains a latex polymer.

In the present specification, the latex polymer is a dispersion in which water-insoluble hydrophobic polymers are dispersed as fine particles in a water-soluble dispersion medium. The dispersed state may be one in which spherical polymer-polymerized particles and/or a polymer are emulsified in a dispersion medium, one in which spherical polymer-polymerized particles and/or a polymer underwent emulsion polymerization, one in which spherical polymer-polymerized particles and/or a polymer underwent micelle dispersion, one in which polymer molecules partially have a hydrophilic structure and thus the molecular chains themselves are dispersed in a molecular state, or the like. Among them, spherical polymer-polymerized particles are particularly preferable.

The receptor layer may also use, other than the latex polymer as a receptor polymer which receives the dye migrated from the heat-sensitive transfer sheet and thereby forms a recorded image at the time of heat-sensitive transfer, a latex polymer having the other functions in combination for the purpose of, for example, regulating the elastic modulus of a film.

The average particle diameter of the dispersed particles of the latex polymer used in the receptor layer is preferably 1 to 1,000 nm, particularly preferably 5 to 500 nm.

Examples of thermoplastic resins used in the latex polymer used in the receptor layer in the present invention include polycarbonates, polyesters, polyacrylates, vinyl chloride-series copolymers, polyurethane, styrene/acrylonitrile copolymers, polycaprolactone and the like.

Among them, polyesters, polyacrylates, and vinyl chloride-series copolymers are preferable, polyesters and vinyl chloride-series copolymers are particularly preferable, vinyl chloride-series copolymers are most preferable.

In the present specification, the vinyl chloride-series copolymer is a copolymer prepared with vinyl chloride as a polymerization monomer and other monomers, and examples thereof include vinyl chloride-vinyl acetate copolymers, vinyl chloride-acrylate copolymers, vinyl chloride-methacrylate copolymers, vinyl chloride-vinyl acetate-acrylate copolymers, and vinyl chloride-acrylate-ethylene copolymers. As described above, the copolymer may be a binary copolymer or a ternary or higher copolymer, and the monomers may be distributed randomly or uniformly by block copolymerization.

The copolymer may contain a unit derived from an auxiliary monomer component such as vinylalcohol derivatives, maleic acid derivatives, and vinyl ether derivatives.

It is preferable that the vinyl chloride-series copolymer used in the present invention contains vinyl chloride as a main component. The phrase “contain vinyl chloride as a main component” means that the vinyl chloride component is contained at a proportion of 50% by mole or more, and it is preferable that the vinyl chloride component is contained at a proportion of 50% by mole or more, while auxiliary monomer components such as a maleic acid derivative and a vinyl ether derivative are contained at a proportion of 10% by mole or less.

In the present invention, the latex polymers used in the receptor layer may be used singly or as a mixture of two or more thereof. The latex polymer used in the receptor layer may have a uniform structure or a core/shell structure, and in the latter case, the resins constituting the core and the shell, respectively, may have different glass transition temperatures.

In the present invention, the glass transition temperature (Tg) of the latex polymer used in the receptor layer is preferably −30° C. to 100° C., more preferably 0° C. to 90° C., further preferably 20° C. to 90° C., and further more preferably 40° C. to 90° C.

The glass transition temperature (Tg), if not practically measurable, may be calculated according to the following formula.

1/Tg=Σ(Xi/Tgi)

wherein, assuming that the polymer is a copolymer composed of n monomers from i=1 to i=n; Xi is a mass fraction of the i-th monomer (ΣXi=1); Tgi is a glass transition temperature (measured in absolute temperature) of a homopolymer formed from the i-th monomer; and the symbol E means the sum of i=1 to i=n. The value of the glass transition temperature of a homopolymer formed from each monomer (Tgi) can be adopted from J. Brandrup and E. H. Immergut, “Polymer Handbook, 3rd. Edition”, Wiley-Interscience (1989).

The latex polymer preferably used in the present invention is such that the polymer concentration is preferably 10 to 70% by mass, and more preferably 20 to 60% by mass, based on the latex liquid. The total addition amount of the latex polymer in the receptor layer is such that the solid content of the latex polymer is preferably 50 to 98% by mass, and more preferably 70 to 95% by mass, based on the total amount of the polymer in the receptor layer.

As a preferable embodiment of the latex polymer, latex polymers such as acrylic-series polymers; polyesters; rubbers (e.g., SBR resins); polyurethanes; polyvinyl chloride copolymers including copolymers such as vinyl chloride/vinyl acetate copolymer, vinyl chloride/acrylate copolymer, and vinyl chloride/methacrylate copolymer; polyvinyl acetate copolymers including copolymers such as ethylene/vinyl acetate copolymer; and polyolefins; are preferably used. These latex polymers may be straight-chain, branched, or cross-linked polymers, the so-called homopolymers obtained by polymerizing single type of monomers, or copolymers obtained by polymerizing two or more types of monomers. In the case of the copolymers, these copolymers may be either random copolymers or block copolymers. The molecular weight of each of these polymers is preferably 5,000 to 1,000,000, and further preferably 10,000 to 500,000 in terms of number-average molecular weight.

The latex polymer used in the present invention is preferably exemplified by polyester latex, or any one of vinyl chloride latex copolymers such as vinyl chloride/acrylic compound latex copolymer, vinyl chloride/vinyl acetate latex copolymer, and vinyl chloride/vinyl acetate/acrylic compound latex copolymer, or arbitrary combinations thereof.

Examples of the vinyl chloride-based copolymer latex include VINYBLAN 240, VINYBLAN 270, VINYBLAN 276, VINYBLAN 277, VINYBLAN 375, VINYBLAN 380, VINYBLAN 386, VINYBLAN 410, VINYBLAN 430, VINYBLAN 432, VINYBLAN 550, VINYBLAN 601, VINYBLAN 602, VINYBLAN 609, VINYBLAN 619, VINYBLAN 680, VINYBLAN 680S, VINYBLAN 681N, VINYBLAN 683, VINYBLAN 685R, VINYBLAN 690, VINYBLAN 860, VINYBLAN 863, VINYBLAN 685, VINYBLAN 867, VINYBLAN 900, VINYBLAN 938 and VINYBLAN 950 (trade names, manufactured by Nissin Chemical Industry Co., Ltd.); and SE1320, S-830 (trade names, manufactured by Sumica Chemtex). In the present invention, these are preferable latex polymers.

The latex polymer other than the vinyl chloride-based copolymer latex may include a polyester-based latex polymer. The polyester-based latex polymer is exemplified by Vylonal MD1200, Vylonal MD1220, Vylonal MD1245, Vylonal MD1250, Vylonal MD1500, Vylonal MD1930, Vylonal MD1985 (trade names, manufactured by Toyobo Co., Ltd.).

Even among these, vinyl chloride copolymer latexes such as a vinyl chloride/acrylic compound copolymer latex (particularly, a vinyl chloride/acrylic acid ester copolymer latex), a vinyl chloride/vinyl acetate copolymer latex, and a vinyl chloride/vinyl acetate/acrylic compound copolymer latex (particularly, a vinyl chloride/vinyl acetate/acrylic acid ester copolymer latex) are particularly preferred, and a vinyl chloride/acrylic compound copolymer latex is most preferred.

### (Water-Soluble Polymer)

The image-receiving sheet of the present invention may contain a water-soluble polymer in the receptor layer. A gelatin, a polyvinyl alcohol, a polyvinylpyrrolidone, and polyvinylpyrrolidone copolymers are preferably used. Among them, gelatin is preferably used, for the reason that gelatin has good setting property at the time of coating. These water-soluble polymers are effective in controlling hydrophilicity and hydrophobicity of the receptor layer, and if the water-soluble polymer is used in a non-excessive amount, dye transfer from the ink sheet is well, and also, a good transfer density is obtained.

The amount of use of the water-soluble polymer is preferably 0.1 to 10% by mass, and more preferably 0.5 to 5% by mass, relative to the total mass of the solid content in the receptor layer.

### (Polyether-Modified Silicone)

In the image-receiving sheet of the present invention, the receptor layer contains a polyether-modified silicone.

The polyether-modified silicone has been originally used as a releasing agent, but it was found in the present invention that the polyether-modified silicone is effective in preventing gloss unevenness in the high-density image areas, which is one of the problems of the present invention to be solved.

The polyether-modified silicone is preferably a liquid at 25° C.

It is also preferable that the polyether-modified silicone is a non-reactive compound and do not contain an epoxy group.

The polyether-modified silicone preferably used in the present invention is preferably a single-terminal-modified type polymer represented by the following formula (1), a both-terminal-modified type polymer represented by the following formula (2), a side chain-modified type polymer represented by the following formula (3), or a main chain copolymer type polymer represented by the following formula (4).

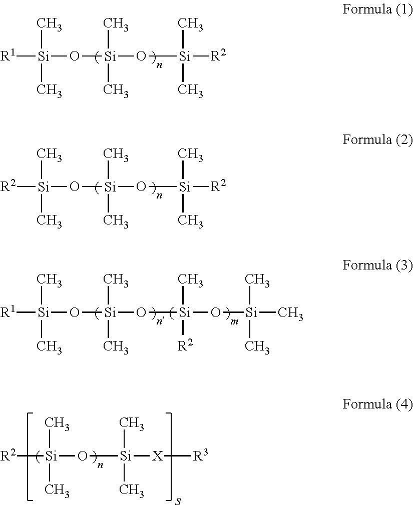

In the formulae (1) to (4), R¹ represents an alkyl group; R² represents —Y—(C₂H₄O)ₐ—(C₃H₆O)_{b}—R⁴; R³ represents a hydrogen atom, an acyl group having an acyl moiety, a monovalent alkyl group, a monovalent cycloalkyl group, and a monovalent aryl group; R⁴ each independently represents a hydrogen atom, an acyl group, an alkyl group, a cycloalkyl group, and an aryl group; Y represents a single bond or a divalent linking group; X represents a divalent linking group; n represents a positive number; n′ represents 0 or a positive integer; m represents 0 or a positive number; s represents a positive number; a and b each independently represents 0 or a positive number, but a and b are not 0 at the same time; n and m are not 0 at the same time.

The alkyl group represented by R¹ may represent a branched alkyl group. The alkyl group represented by R¹ is preferably an alkyl group having 1 to 20 carbon atoms, more preferably 1 to 8 carbon atoms, still more preferably 1 to 4 carbon atoms. Among them, a methyl group and an ethyl group are preferable and a methyl group is most preferable.

The acyl group having an acyl moiety represented by R³ includes, for example, an acetyl group, a propionyl group, a buthylyl group, and a benzoyl group. Among these acyl groups, an acyl group having 2 to 20 carbon atoms is preferable and an acyl group having 2 to 10 carbon atoms is more preferable.

The monovalent alkyl group represented by R³ includes, for example, a methyl group, an ethyl group, a propyl group, an isopropyl group, a buthyl group, and a tert-buthyl group. The monovalent alkyl group is preferably a monovalent alkyl group having 1 to 20 carbon atoms, more preferably 1 to 10.

The monovalent cycloalkyl group represented by R³ includes, for example, a cyclopenthyl group and a cyclohexyl group. The monovalent cycloalkyl group is preferably a monovalent cycloalkyl group having 5 to 10 carbon atoms.

The monovalent aryl group represented by R³ includes, for example, a phenyl group and a naphthyl group. An aryl moiety of the monovalent aryl group is preferably a benzene ring.

R³ preferably represents a monovalent alkyl group.

The acyl group represented by R⁴ is preferably an acyl group having 20 or less carbon atoms, more preferably 10 or less, still more preferably 5 or less, most preferably an acethyl group.

The alkyl group represented by R⁴ may represent a branched alkyl group. The alkyl group represented by R⁴ is preferably an alkyl group having 1 to 20 carbon atoms, more preferably 1 to 8, still more preferably 1 to 4. Among them, a methyl group, an ethyl group, and a buthyl group are preferable, and a methyl group is most preferable.

The cycloalkyl group represented by R⁴ is preferably a cyclopentyl group and a cyclohexyl group.

The aryl group represented by R⁴ may have a substituent, and includes, for example, a phenyl group and a naphtyl group, and preferably a phenyl group. The substituent preferably includes, for example, an alkyl group and a halogen atom. An unsubstituted phenyl group is most preferable.

R⁴ preferably represents a hydrogen atom, an acyl group, an alkyl group and an aryl group. Among them, a hydrogen atom, an acyl group and an alkyl group are more preferable, and an alkyl group is still more preferable.

The divalent linking groups represented by X and Y are each independently preferably an alkylene group and an alkyleneoxy group. The alkylene group preferably includes, for example, a methylene group, an ethylene group, and a propylene group. The alkyleneoxy group preferably includes, for example, —CH₂CH₂O—, —CH(CH₃)CH₂O—, —CH₂CH(CH₃)O—, and —(CH₂)₃O—. The divalent linking group preferably has 1 to 4 carbon atoms and more preferably 2 or 3.

In addition, X and Y preferably represent a single bond and the preferred divalent linking group.

More preferably, Y represents an alkyleneoxy group, most preferably, Y represents a propyleneoxy group (—(CH₂)₃O—).

a and b each independently preferably represents 0 or an integer of 1 or more, more preferably 0 to 500, still more preferably 0 to 200.

n preferably represents 1 to 1,000. n′ and m preferably represents 0 to 1,000.

s preferably represents 1 to 10, more preferably 1 to 6, still more preferably 1 to 4.

Among the polyether-modified silicones represented by the formulas (1) to (4), the polyether-modified silicones represented by the formulas (2) to (4) are preferred in view of releasing action, and the polyether-modified silicone represented by the formulas (2) or (3) is more preferred. In view of the action of preventing gloss unevenness in the high-density image areas, which is one of the problems of the present invention to be solved, the polyether-modified silicone represented by the formula (3) is most preferred.

The polyether-modified silicone is such that the HLB (Hydrophile-Lipophile Balance) value is preferably 5 to 9, and more preferably 5 to 7. If the HLB value is too low, the polyether-modified silicone separates and aggregates in the coating liquid, and causes a defect in the surface state. If the HLB value is too high, the releasing effect and the orientation effect to the surface of the latex particles are small, and sufficient effects are not exhibited.

In the present invention, the HLB value is determined by a calculation formula defined by the following expression based on the Griffin's method (“Kaimennkasseizaibinnrann (Handbook of Surfactant),” co-authored by Ichiro Nishi, Tooziro Imai and Masai Kasai, published by Sangyo Tosho Co., Ltd., 1960).

HLB=20×Mw/M

Here, M represents the molecular weight, and Mw represents the formula weight (molecular weight) of the hydrophilic moiety. In addition, M=Mw+Mo, wherein Mo is the formula weight (molecular weight) of the lipophilic moiety. The hydrophilic moiety in this case is an ethyleneoxy group.

Specific examples of the polyether-modified silicone oil preferably used in the present invention include KF-351A, KF-352A, KF-353, KF-354L, KF-355A, KF-615A, KF-945, KF-640, KF-642, KF-643, KF-6020, KF-6011, KF-6012, KF-6015, KF-6017, X-22-4515, and X-22-6191, manufactured by Shin-Etsu Chemical Co., Ltd.; SH3749, SH3773M, SH8400, SF8427, SF8428, FZ-2101, FZ-2104, FZ-2110, FZ-2118, FZ-2162, FZ-2203, FZ-2207, FZ-2208, FZ-77, L-7001, and L-7002, manufactured by Dow Corning Toray Co., Ltd. (all trade names).

The polyether-modified silicone oil preferably used in the present invention can be easily synthesized by the methods described in, for example, JP-A-2002-179797, JP-A-2008-1896, and JP-A-2008-1897, or methods equivalent to these methods.

In the present invention, the polyether-modified silicone oil can be used singly, or in combination of two or more kinds thereof can also be used. Also, in the present invention, the other releasing agent may be used in combination with the polyether-modified silicone oil.

The addition amount of the polyether-modified silicone oil is preferably 1% by mass to 20% by mass, and more preferably 1% by mass to 10% by mass, based on the total amount of the latex polymer in the receptor layer.

The coating amount of the receptor layer in the present invention is preferably 0.5 to 10.0 g/m², and more preferably 1.0 to 8.0 g/m². The term “coating amount” in the present specification is a value calculated in terms of the solid content, unless particularly stated otherwise.

### <Heat Insulation Layer>

The heat-sensitive transfer image-receiving sheet of the present invention contains at least one heat insulation layer. The heat insulation may be a single layer or double or more multiple layers. The heat insulation layer is formed between the receptor layer and the support.

### (Hollow Polymer Particle)

In the present invention, the heat insulation layer preferably contains hollow polymer particles.

The hollow polymer particles (hereinafter, also referred to as hollow particles) in the present invention are polymer particles having voids inside of the particles. The hollow polymer particles are preferably aqueous dispersion. Examples of the hollow polymer particles include (1) non-foaming type hollow particles obtained in the following manner: a dispersion medium such as water is contained inside of a capsule wall formed of a polystyrene, acrylic resin, styrene/acrylic resin, or the like, and, after a coating liquid is applied and dried, the water in the particles is vaporized out of the particles, with the result that the inside of each particle forms a hollow; (2) foaming type microballoons obtained in the following manner: a low-boiling-point liquid such as butane and pentane, is encapsulated in a resin constituted of any one of polyvinylidene chloride, polyacrylonitrile, polyacrylic acid, and polyacrylate, or their mixture or polymer, and after the resin coating material is applied, it is heated to expand the low-boiling-point liquid inside of the particles, whereby the inside of each particle is made to be hollow; and (3) microballoons obtained by foaming the above (2) under heating in advance, to make hollow polymer particles.

Of these, non-foaming hollow polymer particles of the foregoing (1) are preferred. If necessary, use can be made of a mixture of two or more kinds of hollow polymer particles. Specific examples of the above (1) include Rohpake HP-1055, manufactured by Rohm and Haas Co.; SX866(B), manufactured by JSR Corporation; and Nippol MH5055, manufactured by Nippon Zeon (all of these product names are trade names).

The average particle diameter (particle size) of the hollow particles is preferably 0.5 to 5.0 μm, more preferably 0.5 to 2.0 μm. If the average particle size of the hollow particles is not too small, the film can be designed to have high void ratio (porosity ratio) so that high heat insulation properties are obtained. If the average particle size of the hollow particles is not too large, collapse of the hollow particles due to film contraction during the drying step upon production does not occur easily.

The average particle diameter (size) of the hollow polymer particles used in the present invention is calculated after measurement of the circle-equivalent diameter of the periphery of particle under a transmission electron microscope. The average particle diameter is determined by measuring the circle-equivalent diameter of the periphery of at least 300 hollow polymer particles observed under the transmission electron microscope and obtaining the average thereof.

The hollow particles used in the present invention are such that the void ratio (hollow ratio) is preferably about 20 to 80%, and more preferably about 30 to 70%. If the hollow ratio is not too low, high heat insulation properties are obtained. On the other hand, if the hollow ratio is not too high, there occurs no decrease in the strength of the hollow particles, and collapse of the hollow particles due to film contraction during the drying step upon production does not occur easily.

The hollow ratio of the hollow particles used in the present invention can be determined by observing at least 300 hollow particles using a transmission electron microscope, computing the average circle-equivalent diameter of the outer diameters (R1) and the average circle-equivalent diameter of the inner diameters (R2), and calculating the volume ratio of the void portion to the particle volume, (R2/R1)³×100.

The glass transition temperature (Tg) of the hollow particles is preferably 70° C. or more and 200° C. or less, more preferably 90° C. or more and 180° C. or less. As the hollow particles, it is particularly preferable to use a hollow polymer particle latex such as a latex polymer having hollow particles dispersed in water.

In the image-receiving sheet of the present invention, the ratio of the total volume of the hollow particles occupying in the total volume of the heat insulation layer is preferably 30% to 90%, and more preferably 50% to 80%.

The ratio of the total solid content of the hollow particles occupying in the total solid content of the heat insulation layer is preferably 20% by mass to 80% by mass, and more preferably 30% by mass to 70% by mass.

In the present invention, when there are two or more heat insulation layers, for example, it is preferable embodiment that the heat insulation layers is divided into an upper heat insulation layer and a lower heat insulation layer.

### (Gelatin)

In the present invention, it is preferable that the heat insulation layer contains gelatin. The gelatin used in the present invention may be any of a so-called alkali-treated (lime-treated) gelatin obtained by immersing gelatin in an alkali bath, an acid-treated gelatin obtained by immersing gelatin in an acid bath, a double-immersed gelatin obtained by immersing gelatin in both of an alkali bath and an acid bath before gelatin extraction during the production process, and an enzyme-treated gelatin. Gelatin having a molecular weight of 10,000 to 1,000,000 may be used in the present invention. Gelatin that can be used in the present invention may contain an anion such as Cl⁻ and SO₄²⁻, or alternatively a cation such as Fe2+, Ca²⁺, Mg²⁺, Sn²⁺, and Zn²⁺. Gelatin is preferably added as an aqueous solution.

(Water-Soluble Polymer Other than Gelatin)

In the present invention, the heat insulation layer may contain water-soluble polymers other than gelatin. The water-soluble polymer which can be used in the present invention other than gelatin includes natural polymers (polysaccharide type, microorganism type, and animal type), semi-synthetic polymers (cellulose-based, starch-based, and alginic acid-based), and synthetic polymer type (vinyl type and others); and synthetic polymers including polyvinyl alcohols, and natural or semi-synthetic polymers using celluloses derived from plant as starting materials, which will be explained later, correspond to the water-soluble polymer usable in the present invention.

Among the water-soluble polymers, other than gelatin, which can be used in the present invention, the natural polymers and the semi-synthetic polymers will be explained in detail. Specific examples include the following polymers: plant type polysaccharides such as gum arabics, κ-carrageenans, ι-carrageenans, λ-carrageenans, guar gums (e.g. Supercol, manufactured by Squalon), locust bean gums, pectins, tragacanths, corn starches (e.g. Purity-21, manufactured by National Starch & Chemical Co.), and phosphorylated starches (e.g. National 78-1898, manufactured by National Starch & Chemical Co.); microbial type polysaccharides such as xanthan gums (e.g. Keltrol T, manufactured by Kelco) and dextrins (e.g. Nadex 360, manufactured by National Starch & Chemical Co.); animal type natural polymers such as caseins, sodium chondroitin sulfates (e.g. Cromoist CS, manufactured by Croda); cellulose-based polymers such as ethylcelluloses (e.g. Cellofas WLD, manufactured by I.C.I.), carboxymethylcelluloses (e.g. CMC, manufactured by Daicel), hydroxyethylcelluloses (e.g. HEC, manufactured by Daicel), hydroxypropylcelluloses (e.g. Klucel, manufactured by Aqualon), methylcelluloses (e.g. Viscontran, manufactured by Henkel), nitrocelluloses (e.g. Isopropyl Wet, manufactured by Hercules), and cationated celluloses (e.g. Crodacel QM, manufactured by Croda); starches such as phosphorylated starches (e.g. National 78-1898, manufactured by National Starch & Chemical Co.); alginic acid-based compounds such as sodium alginates (e.g. Keltone, manufactured by Kelco) and propylene glycol alginates; and other polymers such as cationated guar gums (e.g. Hi-care 1000, manufactured by Alcolac) and sodium hyaluronates (e.g. Hyalure, manufactured by Lifecare Biomedial) (all of the names are trade names).

Among the water-soluble polymers, other than gelatin, which can be used in the present invention, the synthetic polymers will be explained in detail. Examples of the acryl type include sodium polyacrylates, polyacrylic acid copolymers, polyacrylamides, polyacrylamide copolymers, and polydiethylaminoethyl(meth)acrylate quaternary salts or their copolymers. Examples of the vinyl type include polyvinylpyrrolidones, polyvinylpyrrolidone copolymers, and polyvinyl alcohols. Examples of the others include polyethylene glycols, polypropylene glycols, polyisopropylacrylamides, polymethyl vinyl ethers, polyethyleneimines, polystyrenesulfonic acids or their copolymers, naphthalenesulfonic acid condensate salts, polyvinylsulfonic acids or their copolymers, polyacrylic acids or their copolymers, acrylic acid or its copolymers, maleic acid copolymers, maleic acid monoester copolymers, acryloylmethylpropanesulfonic acid or its copolymers, polydimethyldiallylammonium chlorides or their copolymers, polyamidines or their copolymers, polyimidazolines, dicyanamide type condensates, epichlorohydrin/dimethylamine condensates, Hofmann decomposed products of polyacrylamides, and water-soluble polyesters (Plascoat Z-221, Z-446, Z-561, Z-450, Z-565, Z-850, Z-3308, RZ-105, RZ-570, Z-730 and RZ-142 (all of these names are trade names), manufactured by Goo Chemical Co., Ltd.). Among them, polyvinyl alcohols are preferably used.

The polyvinyl alcohol used in the present invention includes, for example, PVA-105, PVA-110, PVA-117, PVA-120, PVA-124, PVA-203, PVA-204, PVA-205, PVA-210, PVA-217, PVA-220, PVA-224, PVA-228, PVA-235, PVA-403, and PVA-405 (all trade names, manufactured by KURARAY CO., LTD).

Among the preferred water-soluble polymers mentioned above, it is preferable to use polyvinyl alcohol or gelatin. These polymers can be used singly or in the mixture thereof, and more preferably, gelatin is used.

The coating amount of the heat insulation layer used in the present invention is preferably 5.0 to 40.0 g/m² and more preferably 10.0 to 30.0 g/m².

### <Intermediate Layer>

The heat-sensitive transfer image-receiving sheet of the present invention may have at least one intermediate layer between the heat insulation layer and the receptor layer. The intermediate layer is a layer that is appropriately provided, for example, for the purpose of imparting adhesiveness to the upper and lower layers, or for the purpose of imparting cushioning properties to the image-receiving sheet.

It is particularly preferable that the intermediate layer of the heat-sensitive transfer image-receiving sheet of the present invention contains a latex polymer.

The latex polymer is not particularly limited, but the latex polymer is selected from latex polymers such as a polyurethane, a styrene-butadiene copolymer (SBR latex), an acrylonitrile-butadiene copolymer (NBR latex), a methyl methacrylate-butadiene copolymer (MBR latex), a styrene-acrylic copolymer, a polyacrylic acid ester, a polymethacrylic acid ester, a polymethacrylic acid ester, polyvinyl acetate, a vinyl chloride-vinyl acetate copolymer, an ethylene-vinyl acetate copolymer, a styrene-butadiene-acrylic copolymer, a polyvinylidene chloride, and a vinyl chloride-(meth)acrylic acid ester copolymer. Among these, polyurethane, SBR, NBR, MBR and a vinyl chloride/(meth)acrylic acid ester are preferred, SBR and a vinyl chloride-(meth)acrylic acid ester copolymer are more preferred, SBR is most preferred. These latex polymers can be used singly or as mixtures of two or more kinds thereof according to necessity.

Examples of polyurethane-series latex include HYDRAN AP10, AP20, AP30, AP40, APX-101H, 1320NS, 1610NS, 1670NS, 1980NS, HW-337, HW-350, HW-920, and HW-940, manufactured by DIC Corporation; WEM-202U, WEM-3008, WEM-321U, WEM-031U, WBR-016U, WBR-2018U, and WBR-2019, manufactured by TAISEI FINE CHEMICAL CO., LTD; D-1000, D-2000, D-4000, D-6000, and D-9000, manufactured by Dainichiseika Color & Chemicals Mfg. Co., Ltd; NS-155NX, NS-310A, NS-310X, and NS-311X, manufactured by Takamatsu Oil & Fat Co., Ltd; WOE-305 manufactured by Nippon Polyurethane Industry Co., Ltd; Elastron manufactured by Dai-ichi Kogyo Seiyaku Co., Ltd (all trade names).

Examples of methylmethacrylate-butadiene latex copolymers include MR-170, MR-171, MR-172, MR-173, MR-174, and MR-180 manufactured by Nippon A & L Inc. (all trade names).

Examples of acrylonitrile-butadiene latex copolymers include SR-141 and SR-142 manufactured by Nippon A & L Inc.; Nipol 1561, 1562, 1571H, 1571C2, 1571CL, LX517A, LX517B, 1577K, LX511A,LX513, LX531, LX531B, LX550, LX550L, LX551, and LX552 manufactured by Zeon Corporation (all trade names).

Examples of the vinyl chloride-(meth)acrylic acid ester copolymer include the vinyl chloride and vinyl chloride copolymer latexes explained previously for the receptor layer.

In the present invention, the intermediate layer may contain a water-soluble polymer. Example of the water-soluble polymers may include the water-soluble polymers described in the section <Heat insulation layer>. Among these water-soluble polymers, polyvinyl alcohol is particularly preferred. These resins can be used singly or in the mixture thereof.

The coating amount of the intermediate layer used in the present invention is preferably 0.5 to 10.0 g/m² and more preferably 1.0 to 5.0 g/m².

### <Subbing Layer>

The heat-sensitive transfer image-receiving sheet of the present invention may have a subbing layer between the support and the heat insulation layer. The subbing layer is a layer that is appropriately provided, for example, for the purpose of imparting adhesiveness to the upper and lower layers, or for the purpose of imparting cushioning properties to the image-receiving sheet. The subbing layer is distinguished from the undercoat layer that is coated preliminarily on the support.

A preferred embodiment of the subbing layer is the same as described in the section <Intermediate layer>, and the constitutions of the subbing layer and the intermediate layer may be identical or different from each other.

The coating amount of the subbing layer used in the present invention is preferably 0.5 to 10.0 g/m² and more preferably 1.0 to 5.0 g/m².

Other than the above layers, for example, a white background controlling layer, a charge controlling layer, an adhesive layer, and a primer layer may be formed. These layers may be formed in the same manner as those described in, for example, each specification of Japanese Patent Nos. 3585599 and 2925244.

### <Support>

As the support that is used for the heat-sensitive transfer image-receiving sheet of the present invention, there may be used typical supports with a preferable example being a water-proof support. The use of the waterproof support makes it possible to prevent the support from absorbing moisture, whereby a fluctuation in the performance of the receptor layer with the lapse of time can be prevented. As the waterproof support, for example, coated paper, laminate paper or synthetic paper may be used. Among them, laminate paper is preferable.

It is conventional that an undercoat layer is coated on the support.

### <Curling Control Layer>

It is preferable to form a curling control layer on the heat-sensitive transfer image-receiving sheet of the present invention, according to the necessity. For the curling control layer, a polyethylene laminate, a polypropylene laminate or the like is used. Specifically, the curling control layer may be formed in a manner similar to those described in, for example, JP-A-61-110135 and JP-A-6-202295.

### <Writing Layer and Charge Controlling Layer>

A writing layer and a charge controlling layer may be provided on the heat-sensitive transfer image-receiving sheet of the present invention, according to the necessity. For the writing layer and the charge controlling layer, an inorganic oxide colloid, an ionic polymer, or the like may be used. As an antistatic agent, any antistatic agents including cationic antistatic agents such as a quaternary ammonium salt and polyamine derivative, anionic antistatic agents such as alkyl phosphate, and nonionic antistatic agents such as fatty acid ester may be used. Specifically, the writing layer and the charge controlling layer may be formed in a manner similar to those described in the specification of Japanese Patent No. 3585585.

### <Other Additive>

The heat-sensitive transfer image-receiving sheet of the present invention may also contain additives in layers other than the receptor layer, if necessary. Examples of these additives that can be incorporated include, in addition to the releasing agent described above, an ultraviolet absorbent, a surfactant, an antiseptic agent, a film-forming, aid, a film-hardening agent, a matting agent (including a lubricating agent), an oxidation inhibitor, and other additives.

### (Ultraviolet Absorbent)

The heat-sensitive transfer image-receiving sheet of the present invention may contain any ultraviolet absorbents. As the ultraviolet absorbents, use can be made of typical inorganic or organic ultraviolet absorbents. As the organic ultraviolet absorbents, use can be made of non-reactive ultraviolet absorbents such as salicylate-series, benzophenone-series, benzotriazole-series, triazine-series, substituted acrylonitrile-series, and hindered amine-series ultraviolet absorbents; copolymers or graft polymers of thermoplastic resins (e.g., acrylic resins) obtained by introducing an addition-polymerizable double bond (e.g., a vinyl group, an acryloyl group, a methacryloyl group), or an alcoholic hydroxyl group, an amino group, a carboxyl group, an epoxy group, or an isocyanate group, to the non-reactive ultraviolet absorbents, subsequently copolymerizing or grafting. In addition, disclosed is a method of obtaining ultraviolet-shielding resins by the steps of dissolving ultraviolet absorbents in a monomer or oligomer of the resin to be used, and then polymerizing the monomer or oligomer (JP-A-2006-21333). In this case, the ultraviolet absorbents may be non-reactive.

Of these ultraviolet absorbents, preferred are benzophenone-series, benzotriazole-series, and triazine-series ultraviolet absorbents. It is preferred that these ultraviolet absorbents are used in combination so as to cover an effective ultraviolet absorption wavelength region according to characteristic properties of the dye that is used for image formation. Besides, in the case of non-reactive ultraviolet absorbents, it is preferred to use a mixture of two or more kinds of ultraviolet absorbents each having a different structure from each other so as to prevent the ultraviolet absorbents from precipitation.

Examples of commercially available ultraviolet absorbents include TINUVIN-P (trade name, manufactured by Ciba-Geigy), JF-77 (trade name, manufactured by JOHOKU CHEMICAL Co., Ltd.), SEESORB 701 (trade name, manufactured by SHIRAISHI CALCIUM KAISHA, Ltd.), SUMISORB 200 (trade name, manufactured by Sumitomo Chemical Co., Ltd.), VIOSORB 520 (trade name, manufactured by KYODO CHEMICAL Co., Ltd.), and ADKSTAB LA-32 (trade name, manufactured by ADEKA).

### <Surfactant>

Further, in the heat-sensitive transfer image-receiving sheet of the present invention, a surfactant may be contained in any of such layers as the receptor layer, the heat insulation layer, and the intermediate layer.

An addition amount of the surfactant is preferably from 0.01% by mass to 5% by mass, more preferably from 0.01% by mass to 1% by mass, and especially preferably from 0.02% by mass to 0.2% by mass, based on the total solid content.

With respect to the surfactant, various kinds of not fluorine-containing surfactants such as anionic, nonionic and cationic surfactants are known. As the surfactant that can be used in the present invention, any known surfactants may be used. For example, it is possible to use surfactants as reviewed in “Kinosei kaimenkasseizai (Functional Surfactants)”, editorial supervision of Mitsuo Tsunoda, edition on August in 2000, Chapter 6.

### <Antiseptic>

To the heat-sensitive transfer image-receiving sheet of the present invention, antiseptics may be added. The antiseptics that may be contained in the image-receiving sheet of the present invention are not particularly limited. For example, use can be made of materials described in Bofubokabi (Preservation and Antifungi) HAND BOOK, Gihodo shuppan (1986), Bokin Bokabi no Kagaku (Chemistry of Anti-bacteria and Anti-fungi) authored by Hiroshi Horiguchi, Sankyo Shuppan (1986), Bokin Bokabizai Jiten (Encyclopedia of Antibacterial and Antifungal Agent) edited by The Society for Antibacterial and Antifungal Agent, Japan (1986). Examples thereof include imidazole derivatives, sodium dehydroacetate, 4-isothiazoline-3-on derivatives, benzoisothiazoline-3-on, benzotriazole derivatives, amidineguanidine derivatives, quaternary ammonium salts, pyrrolidine, quinoline, guanidine derivatives, diazine, triazole derivatives, oxazole, oxazine derivatives, and 2-mercaptopyridine-N-oxide or its salt. Of these antiseptics, 4-isothiazoline-3-on derivatives and benzoisothiazoline-3-on are preferred.

### (Film-Forming Aid)

It is preferable to add a high boiling point solvent to the heat-sensitive transfer image-receiving sheet of the present invention. The high boiling point solvent is an organic compound (typically, an organic solvent) which functions as a film-forming aid or a plasticizer, and lowers the lowest film-forming temperature of the latex polymer, and such solvents are described in, for example, “Gosei Latex no Kagaku (Chemistry of Synthetic Latex)”, Soichi Muroi, issued by Kobunshi Kanko Kai (1970). Examples of the high boiling point solvent (film-forming aid) include the following compounds.
Z-1: Benzyl alcohols
Z-2: 2,2,4-Trimethylpentanediol-1,3-monoisobutyrates
Z-3: 2-Dimethylaminoethanols
Z-4: Diethylene glycols

When these high boiling point solvents are added to the image-receiving sheet, spread of image is observed, and it is not preferable for practical use. However, if the content of the solvent in the coating film is not too large, there is no problem in terms of performance.

### <Hardening Agent>

The heat-sensitive transfer image-receiving sheet of the present invention may contain a hardening agent (hardener). The hardening agent may be added to a coated layer such as a receptor layer, a heat insulation layer, and a subbing layer of the heat-sensitive transfer image-receiving sheet.

Preferable examples of the hardener that can be used in the present invention include H-1, 4, 6, 8, and 14 in JP-A-1-214845 in page 17; compounds (H-1 to H-54) represented by any one of formulae (VII) to (XII) in U.S. Pat. No. 4,618,573, columns 13 to 23; compounds (H-1 to H-76) represented by formula (6) in JP-A-2-214852, page 8, the lower right (particularly, H-14); and compounds described in Claim 1 in U.S. Pat. No. 3,325,287. Examples of the hardening agent include hardening agents described, for example, in U.S. Pat. No. 4,678,739, column 41, U.S. Pat. No. 4,791,042, JP-A-59-116655, JP-A-62-245261, JP-A-61-18942, and JP-A-4-218044. More specifically, an aldehyde-series hardening agent (formaldehyde, etc.), an aziridine-series hardening agent, an epoxy-series hardening agent, a vinyl sulfone-series hardening agent (N,N′-ethylene-bis(vinylsulfonylacetamido)ethane, etc.), an N-methylol-series hardening agent (dimethylol urea, etc.), a boric acid, a metaboric acid, or a polymer hardening agent (compounds described, for example, in JP-A-62-234157), can be mentioned. Preferable examples of the hardener include a vinyl sulfone-series hardener and chlorotriazines.

### <Matting Agent>

To the heat-sensitive transfer image-receiving sheet of the present invention, a matting agent may be added in order to prevent blocking, or to give a release property or a sliding (lubricating) property. In the image-receiving layer, the matting agent may be added on the same side as the coating side of the receptor layer, or on the side opposite to the coating side of the receptor layer, or on both sides.

Examples of the matting agent generally include fine particles of water-insoluble organic compounds and fine particles of water-insoluble inorganic compounds. In the present invention, the organic compound-containing fine particles are preferably used from the viewpoints of dispersion properties. In so far as the organic compound is incorporated in the particles, there may be organic compound particles consisting of the organic compound singly, or alternatively organic/inorganic composite particles containing not only the organic compound but also an inorganic compound. As the matting agent, there can be used organic matting agents described in, for example, U.S. Pat. Nos. 1,939,213, 2,701,245, 2,322,037, 3,262,782, 3,539,344, and 3,767,448.

### (Preparation Method of Heat-Sensitive Transfer Image-Receiving Sheet)

The heat-sensitive transfer image-receiving sheet of the present invention is explained below.

The heat-sensitive transfer image-receiving sheet of the present invention has at least one heat insulation layer and at least one receptor layer, and may appropriately have an intermediate layer between the heat insulation layer and the receptor layer. It is preferable to carry out the preparation method such that the respective coating liquids for the layers are coated by simultaneous multi-layer coating on the support.

Such the simultaneous multi-layer coating is preferably an aqueous type coating. The so-called “aqueous type” here means that 60% by mass or more of the solvent (dispersion medium) of the coating solution is water. As a component other than water in the coating solution, a water miscible organic solvent may be used, such as methyl alcohol, ethyl alcohol, isopropyl alcohol, methyl cellosolve, ethyl cellosolve, dimethylformamide, ethyl acetate, diacetone alcohol, furfuryl alcohol, benzyl alcohol, diethylene glycol monoethyl ether, and oxyethyl phenyl ether.

It is known that in the case of producing an image-receiving sheet composed of plural layers having different functions from each other (for example, a heat insulation layer, an intermediate layer and a receptor layer) on a support, it may be produced by applying each layer successively one by one, or by overlapping the layers each already coated on a support or substrate, as shown in, for example, JP-A-2004-106283, JP-A-2004-181888 and JP-A-2004-345267. It has been known in photographic industries, on the other hand, that productivity can be greatly improved, for example, by providing plural layers through simultaneous multi-layer coating. For example, there are known methods such as the so-called slide coating (slide coating method) and curtain coating (curtain coating method) as described in, for example, U.S. Pat. Nos. 2,761,791, 2,681,234, 3,508,947, 4,457,256 and 3,993,019; JP-A-63-54975, JP-A-61-278848, JP-A-55-86557, JP-A-52-31727, JP-A-55-142565, JP-A-50-43140, JP-A-63-80872, JP-A-54-54020, JP-A-5-104061, JP-A-5-127305, and JP-B-49-7050 (“JP-B” means examined Japanese patent publication); and Edgar B. Gutoff, et al., “Coating and Drying Defects: Troubleshooting Operating Problems”, John Wiley & Sons Company, 1995, pp. 101-103. In these coating methods, a plurality of coating liquids is simultaneously supplied to the coating apparatus, thereby to form a plurality of layers different in kinds

As the method for producing the heat-sensitive transfer image-receiving sheet of the present invention, simultaneous multiple-layer coating can be carried out, and from the viewpoint of being capable of realizing high productivity, slide coating or curtain coating is preferred. The heat-sensitive transfer image-receiving sheet of the present invention is generally produced by coating at least one receptor layer and at least one heat insulation layer, on a support by water-based coating. In the case where those layers are respectively constituted of multiple layers, or in the case where the heat-sensitive transfer image-receiving sheet has an intermediate layer or a subbing layer, it is preferable to simultaneously coat all of the layers, including the intermediate layer and the subbing layer, on the support.

In regard to the simultaneous multiple-layer coating, it is necessary to adjust the viscosity and surface tension of the coating liquids to form the respective layers, from the viewpoint of uniform coated layer formation and satisfactory coatability. The viscosity of the coating liquid can be readily adjusted by using a usual thickening agent or thinning agent to the extent that these agents do not affect other performances. Further, the surface tension of the coating liquid can be adjusted by means of various surfactants.

The temperature of these coating liquids for coating various layers is preferably 25° C. to 60° C., and more preferably 30° C. to 50° C. Particularly, the temperature of the coating liquids in the case of using gelatin in the coating liquid is preferably 33° C. to 45° C.

The coated amount of the coating liquid for a layer that constructs the multilayer constitution according to the present invention is preferably in the range of 1 g/m² to 500 g/m². The number of layers in the multilayer constitution can be arbitrarily selected to be two or more. It is preferable that the receptor layer is provided as a layer disposed farthest from the support.

In the drying zone, drying proceeds through: the constant rate period of drying, in which the drying rate is constant, and the material temperature is approximately equal to the wet-bulb temperature; and a falling rate period of drying, in which the drying rate are slowed, and the material temperature rises. In the constant rate drying period, any heat supplied from an external source is all used in the evaporation of moisture. In the falling rate drying period, moisture diffusion inside the material becomes rate-limiting, and the drying rate is lowered due to recession of the evaporation surface or the like. The supplied heat is used in the rising of the material temperature.

In the setting zone and drying zone, moisture migration occurs between the respective coated films (coated layers) and between the support and the coated films, and solidification also occurs due to cooling of the coated films and moisture evaporation. For those reasons, the quality and performance of the resultant product is greatly influenced by the processing history, such as the layer surface temperature during drying and the drying period of time, and it is required to set the conditions in accordance with the demanded quality.

The temperature of the setting zone is generally 15° C. or below, and it is preferable to set the cooling step time period in the range from not less than 5 seconds to less than 30 seconds. If the cooling time period is too short, a sufficient increase of the coating liquid viscosity cannot be obtained, and the surface state is deteriorated upon the subsequent drying step. On the other hand, if the cooling time period is too long, the removal of moisture in the subsequent drying step takes time, and the production efficiency is decreased.

After the cooling step generally at 15° C. or below, drying is carried out in an environment generally at above 15° C. In that case, according to the present invention, it is preferable to adjust the amount of evaporation of water in the coated films that have been coated in multiple layers within 30 seconds after the completion of cooling, to 60% or more of the amount of moisture contained at the layer surface smeared per an area of 1 m² immediately after coating. The terms “amount of moisture contained at the layer surface smeared per an area of 1 m² immediately after coating”, is equal to the water content in the coating liquid prepared before the coating. When the amount of evaporating moisture is not so small, moisture is present on the coated surface not in excess, and the surface state is satisfactory. On the other hand, in the case of adjusting the amount of evaporation to 60% or more, when the drying temperature is brought to a temperature not so higher than 50° C., the evaporation of moisture does not occur rapidly, without causing cracking or the like, and the surface state is satisfactory. Thus, it is preferable to control the drying temperature to 50° C. or below.

Determination of the amount of evaporation can be carried out such that the mass obtained by drying the heat-sensitive transfer image-receiving sheet after coating under the conditions (in an atmosphere) of 110° C. for one hour, is defined as the mass after 100% evaporation, and the difference between the masses before and after drying are measured.

The coating-finished product which has been dried is adjusted to have a certain water content, followed by winding up. Since the progress of film hardening is affected by the water content and temperature during the storage of the wound, coating-finished product, it is necessary to set the conditions for humidification step that are appropriate for the water content in a wound-up state.

In general, the film-hardening reaction can be carried out more easily at higher temperature and higher humidity conditions. However, if the water content is too high, adhesion between the coated products may occur, or there may be a problem in terms of performance. For this reason, it is necessary to set the water content in the wound-up state (humidification conditions) and the storage conditions in accordance with the product quality.

Typical drying devices include an air-loop system and a helical system. The air-loop system is a system in which drying blasts are made to blow on a coated product supported by rollers, and wherein a duct may be mounted either longitudinally or transversely. Such a system has a high degree of freedom in setting of the volume of drying wind, because a drying function and a transporting function are basically separated therein. However, many rollers are used therein, so base-transporting failures, such as gathering, wrinkling and slipping, tend to occur. The helical system is a system in which a coated product is wound round a cylindrical duct in a helical fashion, and transported and dried as it is floated by drying wind (air floating). So no support by rollers is basically required (JP-B-43-20438). In addition to those, there is available a drying system which conveys by reciprocally installing upper and lower ducts and conveying the coated product. In general, this system has a better dryness distribution than that of the helical system, but is poor in floatability.

### (Image-Forming Method)

As an image-forming method (system) using the heat-sensitive transfer image-receiving sheet of the present invention, an image is formed by superposing a heat-sensitive transfer sheet on the heat-sensitive transfer image-receiving sheet of the present invention so that a dye layer (heat transfer layer) of the heat-sensitive transfer sheet is in contact with a receptor layer of the heat-sensitive transfer image-receiving sheet and applying thermal energy to the sheets in accordance with image signals from a thermal head.

Specifically, image-forming can be conducted by the same manner as that described in, for example, JP-A-2005-88545. In the present invention, a printing time is preferably less than 15 seconds, and more preferably in the range of 3 to 12 seconds, and further preferably 3 to 7 seconds, from the viewpoint of shortening a time taken until a consumer gets a print.

In order to accomplish the above-described printing time, a line speed at the time of printing is preferably 2.0 msec/line or less, and more preferably 1.5 msec/line or less, still more preferably 0.73 msec/line or less, most preferably 0.65 msec/line or less. Further, from the viewpoint of improvement in transfer efficiency as one of speeding-up conditions, the highest ultimate temperature of the thermal head at the time of printing is preferably in the range of from 180° C. to 450° C., more preferably from 200° C. to 450° C., and furthermore preferably from 350° C. to 450° C.

The heat-sensitive transfer image-receiving sheet of the present invention may be utilized for printers, copying machines and the like, which employ a heat-sensitive transfer recording system. As a means for providing heat energy in the thermal transfer, any of the conventionally known providing means may be used. For example, application of a heat energy of about 5 to 100 mJ/mm2 by controlling recording time in a recording device such as a thermal printer (trade name: Video Printer VY-100, manufactured by Hitachi, Ltd.), sufficiently attains the expected result. Also, the heat-sensitive transfer image-receiving sheet of the present invention may be used in various applications enabling thermal transfer recording, such as heat-sensitive transfer image-receiving sheets in a form of thin sheets (cut sheets) or rolls; cards; and transmittable type manuscript-making sheets, by optionally selecting the type of support.

### (Heat-Sensitive Transfer Sheet)

The heat-sensitive transfer sheet is a sheet provided, on a support such as polyethylene terephthalate (PET), with coloring material layers formed by dispersing coloring materials of three colors: yellow, magenta and cyan, respectively, in a binder resin, and a transferable protective layer in area order. The coloring material layers may also be composed of layers of four colors, including black.

The term “forming layers in area order” as used in the present specification means forming dye layers each having a different hue and/or function layers in the longitudinal direction on the support of the heat-sensitive transfer sheet, by applying them separately in order.

Examples include the case in which a yellow dye layer, a magenta dye layer, and a cyan dye layer are formed in this order in the longitudinal direction on the support.

Further, any arrangement of these dye layers can be employed, but it is preferred that a yellow dye layer, a magenta dye layer, and a cyan dye layer be arranged sequentially in this order on the support.

### (Binder Resin)

Examples of the binder resins used in the heat-sensitive transfer sheet include acrylic resins such as polyacrylonitrile, polyacrylate, and polyacrylamide; polyvinyl acetal-series resins such as polyvinyl acetoacetal, and polyvinyl butyral; cellulose-series resins such as ethylcellulose, hydroxyethylcellulose, ethylhydroxycellulose, hydroxypropylcellulose, ethylhydroxyethylcellulose, methylcellulose, cellulose acetate, cellulose acetate butyrate, cellulose acetate propionate, cellulose nitrate, other modified cellulose resins, nitrocellulose, and ethylhydroxyethylcellulose; other resins such as polyurethane resin, polyamide resin, polyester resin, polycarbonate resin, phenoxy resin, phenol resin, and epoxy resin; and various elastomers. These may be used singly, or two or more thereof may be used in the form of a mixture or copolymer.

### (Dye)

The dye used in the present invention is not limited, as long as it is able to diffuse by heat and able to be incorporated in a heat-sensitive transfer sheet, and able to transfer by heat from the heat-sensitive transfer sheet to an image-receiving sheet. As the dye used for a heat transfer sheet (heat-sensitive transfer sheet), ordinarily used dyes or known dyes can be effectively used.

Preferable examples of the dye include diarylmethane-series dyes, triarylmethane-series dyes, thiazole-series dyes, methine-series dyes such as merocyanine; azomethine-series dyes typically exemplified by indoaniline, acetophenoneazomethine, pyrazoloazomethine, imidazole azomethine, imidazo azomethine, and pyridone azomethine; xanthene-series dyes; oxazine-series dyes; cyanomethylene-series dyes typically exemplified by dicyanostyrene, and tricyanostyrene; thiazine-series dyes; azine-series dyes; acridine-series dyes; benzene azo-series dyes; azo-series dyes such as pyridone azo, thiophene azo, isothiazole azo, pyrrol azo, pyralazo, imidazole azo, thiadiazole azo, triazole azo, and disazo; spiropyran-series dyes; indolinospiropyran-series dyes; fluoran-series dyes; rhodaminelactam-series dyes; naphthoquinone-series dyes; anthraquinone-series dyes; and quinophthalon-series dyes.

Specific examples of a yellow dye that can be used in the present invention include Disperse Yellow 231, Disperse Yellow 201 and Solvent Yellow 93. Specific examples of a magenta dye that can be used in the present invention include Disperse Violet 26, Disperse Red 60, and Solvent Red 19. Specific examples of a cyan dye that can be used in the present invention include Solvent Blue 63, Solvent Blue 36, Disperse Blue 354 and Disperse Blue 35. As a matter of course, it is also possible to use suitable dyes other than these dyes as exemplified above. Further, dyes each having a different hue from each other as described above may be arbitrarily combined together.

### (Heat Transferable Protective Layer (Laminate))

A heat transferable protective layer (laminate) is used for forming a protective layer composed of a transparent resin on a thermally transferred image by thermal transfer and thus covering and protecting the image, thereby to improve durability such as scratch resistance, light-fastness, and resistance to weather. Such the transparent protective layer (heat transferable protective layer (laminate)) is preferably formed in the case where the dye transferred on the image-receiving sheet is insufficient in image durabilities such as light resistance, scratch resistance, and chemical resistance in the state that the dye is naked in the surface of the image-receiving sheet. As an example, the transferable protective layer laminate can be formed by forming, onto a PET support, a releasing layer, a protective layer and an adhesive layer in this order (i.e., in the layer-described order) successively. The protective layer may be formed by plural layers. In the case where the protective layer also has functions of other layers, the releasing layer and the adhesive layer can be omitted. It is also possible to use the support on which an easy adhesive layer has already been formed.

As a resin forming the protective layer, preferred are resins that are excellent in scratch resistance, chemical resistance, transparency and hardness. Examples of the resin include polyester resins, polystyrene resins, acrylic resins, polyurethane resins, acrylic urethane resins, silicone-modified resins of the above-described resins, mixtures of these resins, ionizing radiation-curable resins, and ultraviolet-shielding resins. In addition, there can be used various kinds of resins that are conventionally known as a resin for forming the protective layer. Further, in order to give ultraviolet absorbing capacity, or to improve coat separation properties at the time of transfer, gloss, brightness, or the like, it is also preferred to add ultraviolet absorbing agents, antioxidants, fluorescent brightening agents, organic fillers and/or inorganic fillers in accordance with necessity.

Depending on the kind of resin for forming the protective layer, the protective layer is formed by the same method as the method of forming the above-described dye layer. A thickness of the protective layer is preferably in the range of from about 0.5 μm to about 10 μm.

In the case where the protective layer is difficult to separate from a support at the time of transfer, it is also a preferable embodiment to form a release (releasing) layer between the support and the protective layer. The release layer can be formed by the steps of preparing a coating liquid composed of a material that is excellent in release properties, such as waxes, silicone wax, silicone resin, and fluorine resin; a relatively high softened point resin that does not melt by heat from a thermal head, such as cellulose-based resin, acrylic resin, polyurethane resin, polyvinyl acetal resin, acrylic vinyl ether-based resin, maleic acid anhydride resin, silicone resin, fluorine resin; or the above-described resins containing a heat release agent such as waxes, and then coating the coating liquid according to a previously known coating method such as gravure coat and gravure reverse coat, followed by drying. Of these resins, preferred are acrylic resins obtained by polymerizing acrylic acid or methacrylic acid singly, or copolymerizing acrylic acid or methacrylic acid with other monomers. These acrylic resins are excellent in adhesion to the support, and release properties from the protective layer. Further, these resins may be used singly or in a combination of these resins.

The release layer remains on the side of a support such as a PET at the time of printing (transfer).

The thickness of the release layer is preferably in the range of from about 0.5 μm to about 5 μm. Various kinds of particles are incorporated in the release layer, or alternatively a surface of the release layer on the protective layer-coating side is subjected to a mat treatment, thereby to mat the surface of the release layer. Resultantly, the surface of the image-receiving sheet after printing can be mat-finished (flatten).

A separation layer may be formed between a transferable protective layer and a release layer. The separation layer is transferred together with the protective layer. After transfer, the separation layer becomes the outermost layer of the printed image-receiving sheet. Therefore, the separation layer is composed of a resin that is excellent in transparency, abrasion resistance and chemical resistance. As the resin, there are exemplified acrylic resin, epoxy resin, polyester resin, and styrene resin. Further, additives such as fillers and waxes may be added to the separation layer.

According to the present invention, there can be provided a high quality heat-sensitive transfer image-receiving sheet, which maintains a coated surface in a good state, is suitable for high-speed printing, has a high value in the highest density, and hardly causes gloss unevenness in the high-density image areas.

The present invention will be described in more detail based on the following examples. Any materials, reagents, amount and ratio of use and operations, as shown in the examples, may appropriately be modified without departing from the spirit and scope of the present invention. It is therefore understood that the present invention is by no means intended to be limited to the specific examples below. In the following Examples, the terms “part” and “%” are values by mass, unless they are indicated differently in particular.

### Examples

### Example 1

### (Production of Sample 100)

A paper support, on both sides of which polyethylene was laminated, was subjected to corona discharge treatment on the surface thereof, and then a gelatin undercoat layer containing sodium dodecylbenzenesulfonate was disposed on the treated surface. A heat insulation layer and a receptor layer each having the following composition were simultaneously multilayer-coated by a slide coating method on the gelatin undercoat layer, in the state that the heat insulation layer and the receptor layer were laminated in this order from the side of the support. The coating was performed so that solid contents of the heat insulation layer and the receptor layer after drying would be 20 g/m² and 5.0 g/m², respectively, to obtain a sample 100.

The coated surface state of the sample 100 was able to be subjected to the evaluation test, but the coated surface state had many spot defects.

### (Composition)

Coating liquid 1 for receptor layer

| | | |
|---|---|---|
| Vinyl chloride/acrylic-series latex | 40 | mass parts |
| (trade name: Vinybran 900, manufactured by | | |
| Nissin Chemicals Co., Ltd.; Vinyl | | |
| chloride/acrylic acid ester copolymmer) | | |
| Gelatin (10% solution) | 2 | mass parts |
| Polyether-modified silicone | 1 | mass part |
| (trade name: both terminals-modified type | | |
| KF-6004, manufactured by Shin-Etsu Chemical | | |
| Co., Ltd.; represented by the formula (2)) | | |
| Water | 54 | mass parts |

### (Composition)

Coating liquid 1 for heat insulation layer

| | |
|---|---|
| Acrylic-series hollow particles | 25 mass parts |
| (trade name: Rohpake HP-1055, | |
| manufactured by Rohm and Haas) | |
| Gelatin (10% solution) | 50 mass parts |
| Water | 27 mass parts |

### (Production of Sample 101)

A sample 101 was prepared in the same manner as the sample 100, except that the coating liquid 1 for receptor layer was changed to a coating liquid 2 for receptor layer having the following composition.

The state of the coated surface of the sample 101 was good.

### (Composition)

Coating liquid 2 for receptor layer

| | | |
|---|---|---|
| Vinyl chloride/acrylic-series latex | 40 | mass parts |
| (trade name: Vinybran 900, manufactured by Nissin | | |
| Chemicals Co., Ltd.) | | |
| Gelatin (10% solution) | 2 | mass parts |
| Polyether-modified silicone | 1 | mass part |
| (trade name: both terminals-modified type KF-6004, | | |
| manufactured by Shin-Etsu Chemical Co., Ltd.; | | |
| represented by the formula (2)) | | |
| Fluorine-containing compound | 5 | mass parts |
| (Compound represented by BSF-1, described in | | |
| JP-A-2007-237617) | | |
| Water | 50 | mass parts |

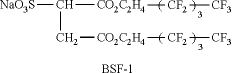

### (Production of Sample 102)

A sample 102 was prepared in the same manner as the sample 101, except that BSF-1 of the sample 101 was changed to the following compound. The compound is a compound represented by BSF-6 in JP-A-2007-237617.

The state of the coated surface of the sample 102 was good.

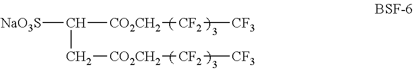

### (Production of Sample 103)

A sample 103 was prepared in the same manner as the sample 101, except that BSF-1 of the sample 101 was changed to the compound (H)-5 represented by the formula (H).

The state of the coated surface of the sample 103 was good.

### (Production of Sample 104)

A sample 104 was prepared in the same manner as the sample 101, except that BSF-1 of the sample 101 was changed to the compound (H)-7 represented by the formula (H).

The state of the coated surface of the sample 104 was good.

### (Production of Sample 105)

A sample 105 was prepared in the same manner as the sample 101, except that BSF-1 of the sample 101 was changed to the compound (H)-3 represented by the formula (H).

The state of the coated surface of the sample 105 was good.

### (Formation of Image)

Fujifilm thermal photoprinter ASK-2000L (trade name, manufactured by FUJIFILM CORPORATION) was used as a printer for image-forming. A heat-sensitive transfer sheet specific for the printer, and the heat-sensitive transfer image-receiving sheets of the samples 100 to 105 were processed to be suitable for loading, and the printing environment was brought under a condition of temperature: 25° C. and humidity: 55%, so that black solid images at the highest density were printed out thereon.

The printed matters described above were evaluated for the glossiness in the high-density image areas.

5. No gloss unevenness is observed, and the image quality is good.

4. Slight gloss unevenness is observed, but to a level that is free of problem in actual use.

3. Some gloss unevenness is observed to a level that may cause a problem in actual use.

2. Obvious gloss unevenness is observed in some areas, to a level that may cause a problem in actual use.

1. Obvious gloss unevenness is observed over the entire area, and the product cannot be used in actual use.

TABLE 1

| | | Fluorine- | Evaluation | State of |
|---|---|---|---|---|
| | | containing | of gloss | coated |
| | | compound | unevenness | surface |
| Sample | Comparative | Not | 3 | Bad |
| 100 | example | contained | | |
| Sample | Comparative | BSF-1 | 2 | Good |
| 101 | example | | | |
| Sample | Comparative | BSF-6 | 2 | Good |
| 102 | example | | | |
| Sample | This | (H)-5 | 4 | Good |
| 103 | invention | | | |
| Sample | This | (H)-7 | 5 | Good |
| 104 | invention | | | |
| Sample | This | (H)-3 | 5 | Good |
| 105 | invention | | | |

The sample 100 did not contain any fluorine-containing compound in the coating liquid for receptor layer, and thus a good coated surface state was not obtained. After relatively uniform areas were selected, printing was performed, and high-density areas were evaluated. Slight gloss unevenness was observed.

While obvious gloss unevenness was observed in some areas of the samples 101 and 102, which were comparative examples each containing a fluorine-containing compound, the gloss unevenness in the high-density image areas was suppressed in the samples 103 to 105, which were the Examples of the present invention added with the fluorine-containing compound represented by the formula (H).

### Example 2

### (Production of Sample 106)

A bilayer coating construct having a coating liquid 2 for heat insulation layer shown below and a coating liquid 3 for receptor layer shown below in this order, was simultaneously multilayer-coated on the same support used for the sample 100 by a slide coating method, and thus a sample 106 was produced.

### (Composition)

Coating liquid 3 for receptor layer

| | | |
|---|---|---|
| Vinyl chloride/acrylic-series latex | 40 | mass parts |
| (trade name: Vinybran 900, manufactured | | |
| by Nissin Chemicals Co., Ltd.) | | |
| Gelatin (10% solution) | 2 | mass parts |
| Polyether-modified silicone | 1 | mass part |
| (trade name: side-chain-modified type L-7001, | | |
| manufactured by Dow Corning Toray Co., Ltd.; | | |
| represented by the formula (3) in which R¹ | | |
| represents a methyl group) | | |
| Fluorine-containing compound (H)-3 represented | 5 | mass parts |
| by the formula (H) | | |
| Water | 50 | mass parts |

### (Composition)

Coating liquid 2 for insulation layer

| | |
|---|---|
| Acrylic-series hollow particles | 30 mass parts |
| (trade name: Rohpake HP-1055, | |
| manufactured by Rohm and Haas) | |
| Gelatin (10% solution) | 50 mass parts |
| Water | 50 mass parts |

### (Production of Sample 107)

A sample 107 was prepared in the same manner as the sample 106, except that the fluorine-containing compound was changed to the fluorine-containing compound (H)-1.

### (Production of Sample 108)

A sample 108 was prepared in the same manner as the sample 106, except that the fluorine-containing compound was changed to the fluorine-containing compound (H)-2.

### (Production of Sample 109)

A sample 109 was prepared in the same manner as the sample 106, except that the fluorine-containing compound was changed to the fluorine-containing compound (H)-4.

### (Production of Sample 110)

A sample 110 was prepared in the same manner as the sample 106, except that the fluorine-containing compound was changed to a fluorine-containing compound (H)-11.

### (Production of Sample 111)

A sample 111 was prepared in the same manner as the sample 106, except that the coating liquid for receptor layer was changed to the following coating liquid 4 for receptor layer. Some gloss unevenness was observed on the coated surface.

### (Composition)

Coating liquid 4 for receptor layer

| | | |
|---|---|---|
| Vinyl chloride/acrylic-series latex | 40 | mass parts |
| (trade name: Vinybran 900, manufactured by | | |
| Nissin Chemicals Co., Ltd.) | | |
| 10% solution of PVA | 2.1 | mass parts |
| (trade name: POVAL PVA 210, manufactured by | | |
| Kuraray) | | |
| Polyether-modified silicone oil | 1 | mass part |
| (trade name: side-chain-modified type KF-352A, | | |
| manufactured by Shin-Etsu Chemical Co., Ltd.; | | |
| represented by the formula (3) in which R¹ | | |
| represents a methyl group) | | |
| Fluorine-containing compound (H)-10 represented | 5 | mass parts |
| by the formula (H) | | |
| Water | 50 | mass parts |

### (Production of Sample 112)

A sample 112 was prepared in the same manner as the sample 108, except that the coating liquid for receptor layer was changed to the following coating liquid 5 for receptor layer.

### (Composition)

Coating liquid 5 for receptor layer

| | | |
|---|---|---|
| Vinyl chloride/vinyl acetate-series latex | 50 | mass parts |
| (trade name: Vinybran 601, manufactured by | | |
| Nissin Chemicals Co., Ltd.) | | |
| Gelatin (10% solution) | 2 | mass parts |
| Polyether-modified silicone | 1 | mass part |
| (trade name: side-chain-modified type KF6012, | | |
| manufactured by Shin-Etsu Chemical Co., Ltd.; | | |
| represented by the formula (3) in which R¹ | | |
| represents a methyl group) | | |
| Fluorine-containing compound (H)-7 represented | 5 | mass parts |
| by the formula (H) | | |
| Water | 50 | mass parts |

### (Production of Sample 113)

A sample 113 was prepared in the same manner as the sample 106, except that the coating liquid for receptor layer was changed to the following coating liquid 6 for receptor layer.

### (Composition)

Coating liquid 6 for receptor layer

| | | |
|---|---|---|
| Polyester-series latex | 50 | mass parts |
| (trade name: MD-1200, manufactured by Toyobo | | |
| Co., Ltd.) | | |
| Gelatin (10% solution) | 2 | mass parts |
| Polyether-modified silicone | 1 | mass part |
| (trade name: side-chain-modified type KF6012, | | |
| manufactured by Shin-Etsu Chemical Co., Ltd.; | | |
| represented by the formula (3) in which R¹ | | |
| represents a methyl group) | | |
| Fluorine-containing compound (H)-9 represented | 5 | mass parts |
| by the formula (H) | | |
| Water | 50 | mass parts |

### (Production of Sample 114)

In the sample 106, the following intermediate layer (2.0 g/m²) was provided between the same insulation layer and receptor layer as the sample 106, and these three layers were simultaneously three layer-coated on the same support by a slide coating method, and thus a sample 114 was produced.

### (Composition)

Coating liquid for intermediate layer

| | |
|---|---|
| Styrene butadiene latex | 60 mass parts |
| (trade name: SR103, manufactured by NIPPON | |
| A & L INC) | |
| 6% solution of PVA | 40 mass parts |
| (trade name: POVAL PVA 210, manufactured | |
| by Kuraray) | |
| NaOH aqueous solution | amount necessary for |
| | adjusting pH to 8 |

### (Production of Sample 115)

In the sample 114, the following subbing layer (3.0 g/m²) was provided between the support and the insulation layer, and the four layers including the subbing layer, and the same insulation layer, intermediate layer, and receptor layer as the sample 114 were simultaneously four layer-coated on the same support by a slide coating method, and thus a sample 115 was produced.

### (Composition)

Coating liquid for subbing layer

| | |
|---|---|
| Styrene butadiene latex | 60 mass parts |
| (trade name: SR103, manufactured by NIPPON | |
| A & L INC) | |
| 6% solution of PVA | 40 mass parts |
| (trade name: POVAL PVA 205, manufactured | |
| by Kuraray) | |
| NaOH aqueous solution | amount necessary for |
| | adjusting pH to 8 |

### (Production of Sample 116)

A sample 116 was prepared in the same manner as the sample 106, except that the fluorine-containing compound (H)-3 was changed to the BSF-6.

### (Formation of Image)

Fujifilm thermal photoprinter ASK-2000L (trade name, manufactured by FUJIFILM CORPORATION) was used as a printer for image-forming. A heat-sensitive transfer sheet specific for the printer, and the heat-sensitive transfer image-receiving sheets of the samples 106 to 116 were processed to be suitable for loading, and the printing environment was brought under severity conditions of temperature: 30° C. and humidity: 80%. Black solid images at the highest density were printed out thereon, and the images were evaluated according to the same criteria as indicated in the Table 1.

TABLE 2

| | | Fluorine- | | State of |
|---|---|---|---|---|
| | | containing | Evaluation of | coated |
| | | compound | gloss unevenness | surface |
| Sample | This | (H)-3 | 5 | Good |
| 106 | invention | | | |
| Sample | This | (H)-1 | 4 | Good |
| 107 | invention | | | |
| Sample | This | (H)-2 | 5 | Good |
| 108 | invention | | | |
| Sample | This | (H)-4 | 4 | Good |
| 109 | invention | | | |
| Sample | This | (H)-11 | 5 | Good |
| 110 | invention | | | |
| Sample | This | (H)-10 | 4 | Relatively |
| 111 | invention | | | bad |
| Sample | This | (H)-7 | 5 | Good |
| 112 | invention | | | |
| Sample | This | (H)-9 | 5 (relatively | Good |
| 113 | invention | | lower density) | |
| Sample | This | (H)-3 | 5 | Good |
| 114 | invention | | | |
| Sample | This | (H)-3 | 5 | Good |
| 115 | invention | | | |
| Sample | Comparative | BSF-6 | 1 | Good |
| 116 | example | | | |

The samples 106 to 115 of the Examples in the scope of the present invention, to which the fluorine-containing compound represented by the formula (H) were added, exhibited excellent effects that gloss unevenness in the high-density image areas can be prevented even under more severe high-temperature and high-humidity printing conditions.

Having described our invention as related to the present embodiments, it is our intention that the invention not be limited by any of the details of the description, unless otherwise specified, but rather be construed broadly within its spirit and scope as set out in the accompanying claims.

This non-provisional application claims priority under 35 U.S.C. § 119 (a) on Patent Application No. 2009-179276 filed in Japan on Jul. 31, 2009, which is entirely herein incorporated by reference.

What we claim is:

1. A heat-sensitive transfer image-receiving sheet, comprising on a support:
at least one heat insulation layer; and
at least one receptor layer containing a latex polymer and polyether-modified silicone in this order,
wherein at least one layer provided on the side of the support having the receptor layer contains at least one fluorine-containing compound represented by formula (H): 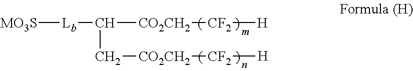
wherein m and n each independently represents an integer of 2 to 8; M represents a cation; and L_{b} represents a single bond or a substituted or unsubstituted alkylene group.

2. The heat-sensitive transfer image-receiving sheet according to claim 1, wherein m and n each independently represents an integer of 2 to 6 in the fluorine-containing compound represented by the formula (H).

3. The heat-sensitive transfer image-receiving sheet according to claim 2, wherein a total value of m and n is from 6 to 12 in the fluorine-containing compound represented by the formula (H).

4. The heat-sensitive transfer image-receiving sheet according to claim 1, wherein the latex polymer is a vinyl chloride copolymer.

5. The heat-sensitive transfer image-receiving sheet according to claim 1, having an intermediate layer between the heat insulation layer and the receptor layer.

6. The heat-sensitive transfer image-receiving sheet according to claim 1, comprising a subbing layer between the support and the heat insulation layer.
